(19) United States
(12) Patent Application Publication
(10) Pub. No.: US 2025/0227611 A1
(43) Pub. Date: Jul. 10, 2025

(54) COORDINATED JOINT-DOMAIN NETWORK ENERGY SAVING

(71) Applicant: Fraunhofer-Gesellschaft zur Förderung der angewandten Forschung e.V., München (DE)

(72) Inventors: Gustavo Wagner OLIVEIRA DA COSTA, Erlangen (DE); Geordie GEORGE, Erlangen (DE); Martin LEYH, Erlangen (DE); Elke ROTH-MANDUTZ, Erlangen (DE); Mehdi HAROUNABADI, Erlangen (DE); Julian POPP, Erlangen (DE); Dietmar LIPKA, Erlangen (DE)

(21) Appl. No.: 19/092,477

(22) Filed: Mar. 27, 2025

Related U.S. Application Data
(63) Continuation of application No. PCT/EP2023/076780, filed on Sep. 27, 2023.

(30) Foreign Application Priority Data
Sep. 28, 2022 (EP) 22198463.6

(51) Int. Cl. H04W 52/02; H04W 16/28; H04W 36/08

(52) U.S. Cl. CPC H04W 52/0206; H04W 16/28; H04W 36/08

(57) ABSTRACT

A base station for operating at least one cell of a wireless communication network and is configured to operate the cell in a capacity mode during a first instance of time and in an energy saving mode during a different second instance of time. In the energy saving mode, the base station provides a lower traffic capacity in the cell when compared to the capacity mode to reduce a level of power consumption in the energy saving mode when compared to the capacity mode.

### CROSS-REFERENCE TO RELATED APPLICATIONS

This application is a continuation of copending International Application No. PCT/EP2023/076780, filed Sep. 27, 2023, which is incorporated herein by reference in its entirety, and additionally claims priority from European Application No. 22198463.6, filed Sep. 28, 2022, which is also incorporated herein by reference in its entirety.

### TECHNICAL FIELD

Embodiments of the present application relate to the field of wireless communication, and more specifically, to wireless communication between a user equipment and a base station. Some embodiments relate to network guided initial network/cell-search.

### BACKGROUND OF THE INVENTION

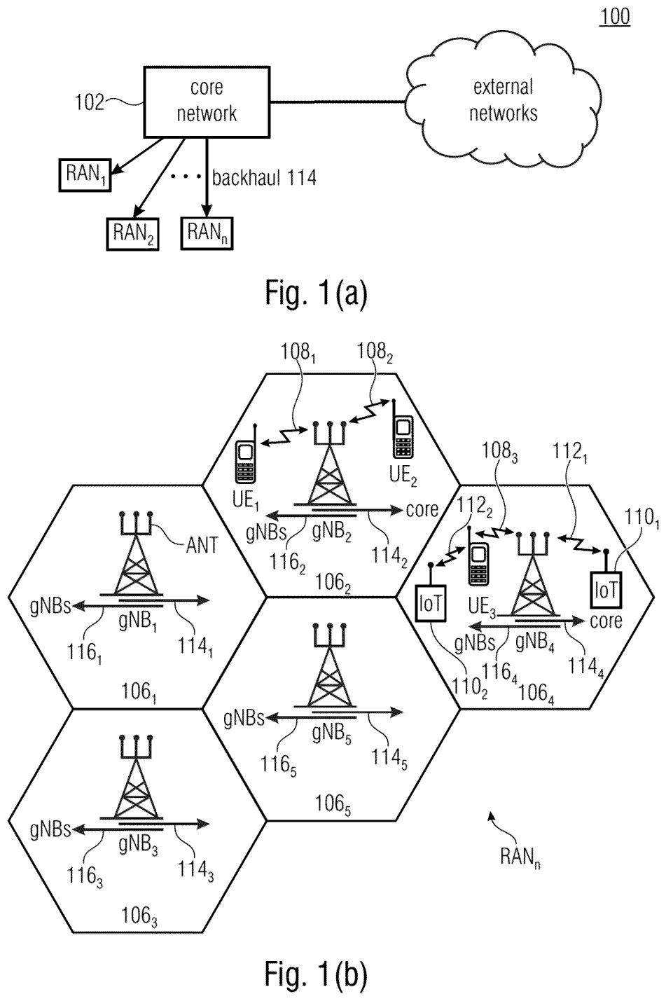

FIG. 1 is a schematic representation of an example of a terrestrial wireless network 100 including, as is shown in FIG. 1(a), a core network 102 and one or more radio access networks RAN1, RAN2, . . . RANN. FIG. 1(b) is a schematic representation of an example of a radio access network RANn that may include one or more base stations gNB1 to gNB5, each serving a specific area surrounding the base station schematically represented by respective cells 1061 to 1065. The base stations are provided to serve users within a cell. The term base station, BS, refers to a transmission reception point (TRP) or a gNB in 5G networks, an eNB in UMTS/LTE/LTE-A/LTE-A Pro, or just a BS in other mobile communication standards. A user may be a stationary device or a mobile device. The wireless communication system may also be accessed by mobile or stationary IoT devices which connect to a base station or to a user. The mobile devices or the IoT devices may include physical devices, ground based vehicles, such as robots or cars, aerial vehicles, such as manned or unmanned aerial vehicles (UAVs), the latter also referred to as drones, buildings and other items or devices having embedded therein electronics, software, sensors, actuators, or the like as well as network connectivity that enables these devices to collect and exchange data across an existing network infrastructure. FIG. 1(b) shows an exemplary view of five cells, however, the RANn may include more or less such cells, and RANn may also include only one base station. FIG. 1(b) shows two users UE1 and UE2, also referred to as user equipment, UE, that are in cell 1062 and that are served by base station gNB2. Another user UE3 is shown in cell 1064 which is served by base station gNB4. The arrows 1081, 1082 and 1083 schematically represent uplink/downlink connections for transmitting data from a user UE1, UE2 and UE3 to the base stations gNB2, gNB4 or for transmitting data from the base stations gNB2, gNB4 to the users UE1, UE2, UE3. Further, FIG. 1(b) shows two IoT devices 1101 and 1102 in cell 1064, which may be stationary or mobile devices. The IoT device 1101 accesses the wireless communication system via the base station gNB4 to receive and transmit data as schematically represented by arrow 1121. The IoT device 1102 accesses the wireless communication system via the user UE3 as is schematically represented by arrow 1122. The respective base station gNB1 to gNB5 may be connected to the core network 102, e.g., via the S1 interface, via respective backhaul links 1141 to 1145, which are schematically represented in FIG. 1(b) by the arrows pointing to “core”. The core network 102 may be connected to one or more external networks. Further, some or all of the respective base station gNB1 to gNB5 may connected, e.g., via the S1 or X2 interface or the XN interface in NR, with each other via respective backhaul links 1161 to 1165, which are schematically represented in FIG. 1(b) by the arrows pointing to “gNBs”.

For data transmission a physical resource grid may be used. The physical resource grid may comprise a set of resource elements to which various physical channels and physical signals are mapped. For example, the physical channels may include the physical downlink, uplink and sidelink shared channels (PDSCH, PUSCH, PSSCH) carrying user specific data, also referred to as downlink, uplink and sidelink payload data, the physical broadcast channel (PBCH) carrying for example a master information block (MIB), the physical downlink shared channel (PDSCH) carrying for example a system information block (SIB), the physical downlink, uplink and sidelink control channels (PDCCH, PUCCH, PSSCH) carrying for example the downlink control information (DCI), the uplink control information (UCI) and the sidelink control information (SCI). For the uplink, the physical channels, or more precisely the transport channels according to 3GPP, may further include the physical random access channel (PRACH or RACH) used by UEs for accessing the network once a UE is synchronized and has obtained the MIB and SIB. The physical signals may comprise reference signals or symbols (RS), synchronization signals and the like. The resource grid may comprise a frame or radio frame having a certain duration in the time domain and having a given bandwidth in the frequency domain. The frame may have a certain number of subframes of a predefined length, e.g., 1 ms. Each subframe may include one or more slots of 12 or 14 OFDM symbols depending on the cyclic prefix (CP) length. All OFDM symbols may be used for DL or UL or only a subset, e.g., when utilizing shortened transmission time intervals (sTTI) or a mini-slot/non-slot-based frame structure comprising just a few OFDM symbols.

The wireless communication system may be any single-tone or multicarrier system using frequency-division multiplexing, like the orthogonal frequency-division multiplexing (OFDM) system, the orthogonal frequency-division multiple access (OFDMA) system, or any other IFFT-based signal with or without CP, e.g., DFT-s-OFDM. Other waveforms, like non-orthogonal waveforms for multiple access, e.g., filter-bank multicarrier (FBMC), generalized frequency division multiplexing (GFDM) or universal filtered multi carrier (UFMC), may be used. The wireless communication system may operate, e.g., in accordance with the LTE-Advanced pro standard or the NR (5G), New Radio, standard.

The wireless network or communication system depicted in FIG. 1 may by a heterogeneous network having distinct overlaid networks, e.g., a network of macro cells with each macro cell including a macro base station, like base station gNB1 to gNB5, and a network of small cell base stations (not shown in FIG. 1), like femto or pico base stations.

In addition to the above described terrestrial wireless network also non-terrestrial wireless communication networks exist including spaceborne transceivers, like satellites, and/or airborne transceivers, like unmanned aircraft systems. The non-terrestrial wireless communication network or system may operate in a similar way as the terrestrial system described above with reference to FIG. 1, for example in accordance with the LTE-Advanced Pro standard or the NR (5G), new radio, standard.

In mobile communication networks, for example in a network like that described above with reference to FIG. 1, like an LTE or 5G/NR network, there may be UEs that communicate directly with each other over one or more sidelink (SL) channels, e.g., using the PC5 interface. UEs that communicate directly with each other over the sidelink may include vehicles communicating directly with other vehicles (V2V communication), vehicles communicating with other entities of the wireless communication network (V2X communication), for example roadside entities, like traffic lights, traffic signs, or pedestrians. Other UEs may not be vehicular related UEs and may comprise any of the above-mentioned devices. Such devices may also communicate directly with each other (D2D communication) using the SL channels.

When considering two UEs directly communicating with each other over the sidelink, both UEs may be served by the same base station so that the base station may provide sidelink resource allocation configuration or assistance for the UEs. For example, both UEs may be within the coverage area of a base station, like one of the base stations depicted in FIG. 1. This is referred to as an “in-coverage” scenario. Another scenario is referred to as an “out-of-coverage” scenario. It is noted that “out-of-coverage” does not mean that the two UEs are not within one of the cells depicted in FIG. 1, rather, it means that these UEs
may not be connected to a base station, for example, they are not in an RRC connected state, so that the UEs do not receive from the base station any sidelink resource allocation configuration or assistance, and/or
may be connected to the base station, but, for one or more reasons, the base station may not provide sidelink resource allocation configuration or assistance for the UEs, and/or
may be connected to the base station that may not support NR V2X services, e.g., GSM, UMTS, LTE base stations.

When considering two UEs directly communicating with each other over the sidelink, e.g., using the PC5 interface, one of the UEs may also be connected with a BS, and may relay information from the BS to the other UE via the sidelink interface. The relaying may be performed in the same frequency band (in-band-relay) or another frequency band (out-of-band relay) may be used. In the first case, communication on the Uu and on the sidelink may be decoupled using different time slots as in time division duplex, TDD, systems.

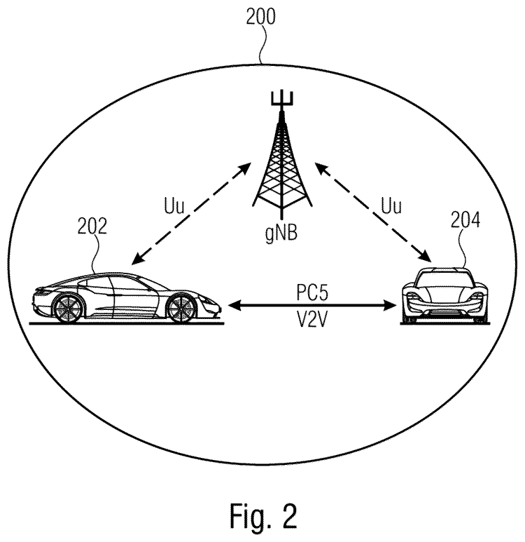

FIG. 2 is a schematic representation of an in-coverage scenario in which two UEs directly communicating with each other are both connected to a base station. The base station gNB has a coverage area that is schematically represented by the circle 200 which, basically, corresponds to the cell schematically represented in FIG. 1. The UEs directly communicating with each other include a first vehicle 202 and a second vehicle 204 both in the coverage area 200 of the base station gNB. Both vehicles 202, 204 are connected to the base station gNB and, in addition, they are connected directly with each other over the PC5 interface. The scheduling and/or interference management of the V2V traffic is assisted by the gNB via control signaling over the Uu interface, which is the radio interface between the base station and the UEs. In other words, the gNB provides SL resource allocation configuration or assistance for the UEs, and the gNB assigns the resources to be used for the V2V communication over the sidelink. This configuration is also referred to as a mode 1configuration in NR V2X or as a mode 3 configuration in LTE V2X.

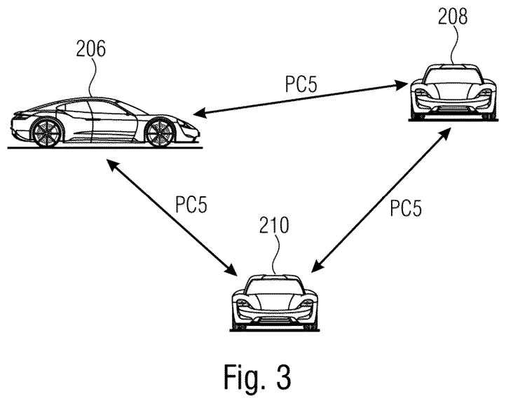

FIG. 3 is a schematic representation of an out-of-coverage scenario in which the UEs directly communicating with each other are either not connected to a base station, although they may be physically within a cell of a wireless communication network, or some or all of the UEs directly communicating with each other are to a base station but the base station does not provide for the SL resource allocation configuration or assistance. Three vehicles 206, 208 and 210 are shown directly communicating with each other over a sidelink, e.g., using the PC5interface. The scheduling and/or interference management of the V2V traffic is based on algorithms implemented between the vehicles. This configuration is also referred to as a mode 2 configuration in NR V2X or as a mode 4 configuration in LTE V2X. As mentioned above, the scenario in FIG. 3 which is the out-of-coverage scenario does not necessarily mean that the respective mode 2 UEs (in NR) or mode 4 UEs (in LTE) are outside of the coverage 200 of a base station, rather, it means that the respective mode 2 UEs (in NR) or mode 4 UEs (in LTE) are not served by a base station, are not connected to the base station of the coverage area, or are connected to the base station but receive no SL resource allocation configuration or assistance from the base station. Thus, there may be situations in which, within the coverage area 200 shown in FIG. 2, in addition to the NR mode 1 or LTE mode 3 UEs 202, 204 also NR mode 2 or LTE mode 4 UEs 206, 208, 210 are present.

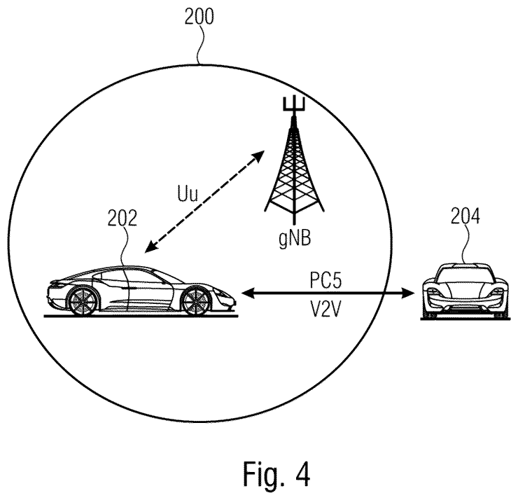

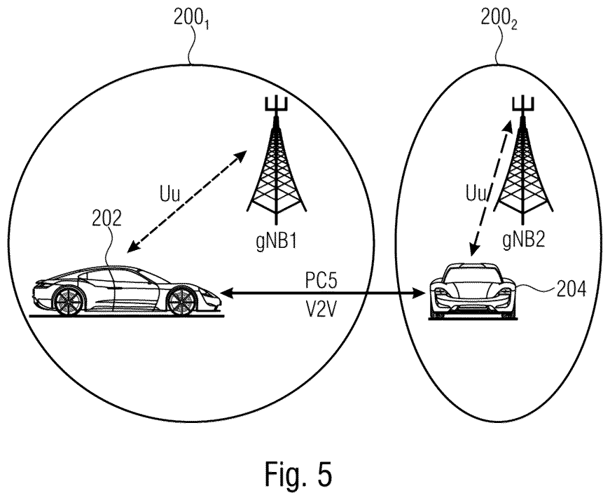

Naturally, it is also possible that the first vehicle 202 is covered by the gNB, i.e. connected with Uu to the gNB, wherein the second vehicle 204 is not covered by the gNB and only connected via the PC5 interface to the first vehicle 202, or that the second vehicle is connected via the PC5 interface to the first vehicle 202 but via Uu to another gNB, as will become clear from the discussion of FIGS. 4 and 5.

FIG. 4 is a schematic representation of a scenario in which two UEs directly communicating with each, wherein only one of the two UEs is connected to a base station. The base station gNB has a coverage area that is schematically represented by the circle 200 which, basically, corresponds to the cell schematically represented in FIG. 1. The UEs directly communicating with each other include a first vehicle 202 and a second vehicle 204, wherein only the first vehicle 202 is in the coverage area 200 of the base station gNB. Both vehicles 202, 204 are connected directly with each other over the PC5 interface.

FIG. 5 is a schematic representation of a scenario in which two UEs directly communicating with each, wherein the two UEs are connected to different base stations. The first base station gNB1 has a coverage area that is schematically represented by the first circle 2001, wherein the second station gNB2 has a coverage area that is schematically represented by the second circle 2002. The UEs directly communicating with each other include a first vehicle 202 and a second vehicle 204, wherein the first vehicle 202 is in the coverage area 2001 of the first base station gNB1 and connected to the first base station gNB1 via the Uu interface, wherein the second vehicle 204 is in the coverage area 2002 of the second base station gNB2 and connected to the second base station gNB2 via the Uu interface.

In a wireless communication system as described above, especially in mobile communication systems, the energy consumption has been increasing dramatically due to the explosion in data demand. This is a large issue both to the Operating Expenses (OpEx) of Network Operators and the environmental concern related to CO² emissions.

Therefore, there is a need to provide and implement techniques which allow cellular systems to save energy.

### SUMMARY

An embodiment may have a base station for operating at least one cell of a wireless communication network, wherein the base station is to operate the cell in a capacity mode during a first instance of time and in an energy saving mode during a different second instance of time; wherein, in the energy saving mode, the base station provides a lower traffic capacity in the cell when compared to the capacity mode to reduce a level of power consumption in the energy saving mode when compared to the capacity mode, wherein in preparation to switch into the energy saving mode, the base station is configured for transmitting an energy saving message, ESM, indicating a beam configuration, e.g., of at least one SSB beam.

Another embodiment may have a base station for operating at least one cell of a wireless communication network: wherein the base station is configured for receiving an indication signal indicating that a different, e.g., neighboring, base station of the wireless communication network intends to switch from an energy saving mode into a capacity mode that provides for a higher traffic capacity when compared to the energy saving mode; or intends to switch from the capacity mode into the energy saving mode; wherein the base station is configured for transmitting a response signal to respond to the indication signal, the response signal containing information indicating an at least partial rejection of the switch and/or an at least partial confirmation of the switch.

Another embodiment may have a base station for operating at least one cell of a wireless communication network: wherein the base station is configured for obtaining information indicating that a neighboring base station switches to an energy saving mode in which the neighboring base station has a reduced coverage when compared to a capacity mode, and to compensate for the reduced coverage, e.g., based on a received corresponding request.

Another embodiment may have a user equipment, UE, configured for operating in a wireless communication network cell being operated by a serving base station, e.g., any of the above inventive base stations, wherein the UE is configured or pre-configured with different energy saving state, ESS, describing an operation of the UE when the serving base station is in an energy saving mode; wherein the UE is adapted to switch between different configurations or pre-configurations based on a received signal, e.g., a lower layer signaling mechanism such as DCI or MAC element.

Another embodiment may have a wireless communication network having a plurality of base stations as mentioned above.

According to another embodiment, a method for operating a base station to operate at least one cell of a wireless communication network may have the step of: controlling the base station to operate the cell in a capacity mode during a first instance of time and in an energy saving mode during a different second instance of time; such that, in the energy saving mode, the base station provides a lower traffic capacity in the cell when compared to the capacity mode to reduce a level of power consumption in the energy saving mode when compared to the capacity mode; and such that in preparation to switch into the energy saving mode, the base station transmits an energy saving message, ESM, indicating a beam configuration, e.g., of at least one SSB beam.

According to another embodiment, a method for operating a base station to operate at least one cell of a wireless communication network may have the steps of: receiving an indication signal indicating that a different, e.g., neighboring, base station of the wireless communication network intends to switch from an energy saving mode into a capacity mode that provides for a higher traffic capacity when compared to the energy saving mode; or intends to switch from the capacity mode into the energy saving mode; and transmitting a response signal to respond to the indication signal, the response signal containing information indicating an at least partial rejection of the switch and/or an at least partial confirmation of the switch.

According to another embodiment, a method for operating a base station to operate at least one cell of a wireless communication network may have the steps of: obtaining information indicating that a neighboring base station switches to an energy saving mode in which the neighboring base station has a reduced coverage when compared to a capacity mode, and compensating for the reduced coverage, e.g., based on a received corresponding request.

According to another embodiment, a method for operating a user equipment, UE, in a wireless communication network cell being operated by a serving base station, e.g., any of the above inventive base stations, wherein the UE is configured or pre-configured with different energy saving state, ESS, describing an operation of the UE when the serving base station is in an energy saving mode, may have the step of: switching the UE between different configurations or pre-configurations based on a received signal, e.g., a lower layer signaling mechanism such as DCI or MAC element.

Still another embodiment may have a non-transitory digital storage medium having a computer program stored thereon to perform any of the above methods when said computer program is run by on a computer, microprocessor or software defined radio.

It is noted that the information in the above section is only for enhancing the understanding of the background of the invention and therefore it may contain information that does not form conventional technology and is already known to a person of ordinary skill in the art.

### BRIEF DESCRIPTION OF THE INVENTION

Embodiments of the present invention are described herein making reference to the appended drawings, in which:

FIG. 1 shows a schematic representation of an example of a wireless communication system;

FIG. 2 is a schematic representation of an in-coverage scenario in which UEs directly communicating with each other are connected to a base station;

FIG. 3 is a schematic representation of an out-of-coverage scenario in which UEs directly communicating with each other receive no SL resource allocation configuration or assistance from a base station;

FIG. 4 is a schematic representation of a partial out-of-coverage scenario in which some of the UEs directly communicating with each other receive no SL resource allocation configuration or assistance from a base station;

FIG. 5 is a schematic representation of an in-coverage scenario in which UEs directly communicating with each other are connected to different base stations;

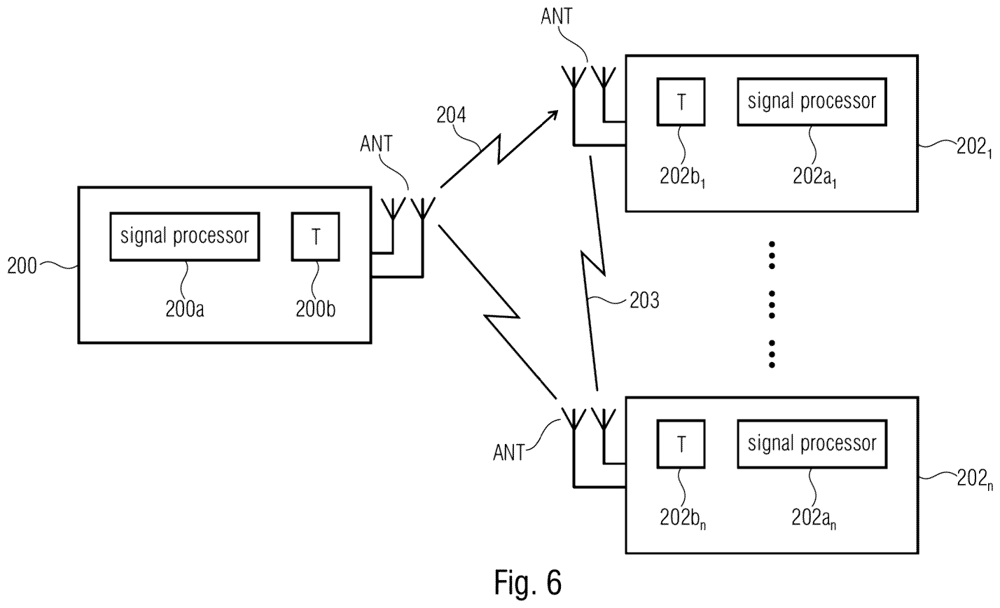

FIG. 6 is a schematic representation of a wireless communication system comprising a transceiver, like a base station or a relay, and a plurality of communication devices, like UEs, according to an embodiment; and

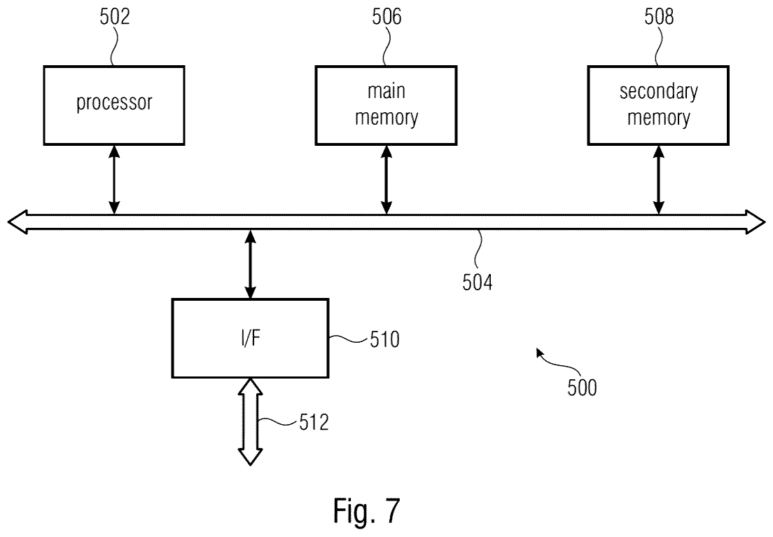

FIG. 7 illustrates an example of a computer system on which units or modules as well as the steps of the methods described in accordance with the inventive approach may execute.

### DETAILED DESCRIPTION OF THE INVENTION

Equal or equivalent elements or elements with equal or equivalent functionality are denoted in the following description by equal or equivalent reference numerals.

In the following description, a plurality of details are set forth to provide a more thorough explanation of embodiments of the present invention. However, it will be apparent to one skilled in the art that embodiments of the present invention may be practiced without these specific details. In other instances, well-known structures and devices are shown in block diagram form rather than in detail in order to avoid obscuring embodiments of the present invention. In addition, features of the different embodiments described hereinafter may be combined with each other, unless specifically noted otherwise.

Embodiments of the present invention may be implemented in a wireless communication system or network as depicted in FIGS. 1 to 5 including a transceiver, like a base station, gNB, or relay, and a plurality of communication devices, like user equipment's, UEs. FIG. 6 is a schematic representation of a wireless communication system comprising a transceiver 200, like a base station or a relay, and a plurality of communication devices 2021 to 202n, like UEs. The UEs might communicated directly with each other via a wireless communication link or channel 203, like a radio link (e.g., using the PC5 interface (sidelink)). Further, the transceiver and the UEs 202 might communicate via a wireless communication link or channel 204, like a radio link (e.g., using the uU interface). The transceiver 200 might include one or more antennas ANT or an antenna array having a plurality of antenna elements, a signal processor 200a and a transceiver unit 200b. The UEs 202 might include one or more antennas ANT or an antenna array having a plurality of antennas, a processor 202a1 to 202an, and a transceiver (e.g., receiver and/or transmitter) unit 202b1 to 202bn. The base station 200 and/or the one or more UEs 202 may operate in accordance with the inventive teachings described herein.

Embodiments relate to a base station for operating at least one cell of a wireless, e.g., radio based, communication network e.g., 5G/NR communications network, comprising:
wherein the base station is adapted, configured or configurable to operate the cell in a capacity mode during a first instance of time and in an energy saving mode during a different second instance of time, e.g., by comprising a control unit that is adapted to control the base station accordingly;
wherein, in the energy saving mode, the base station provides a lower traffic capacity, e.g., related to radio signals, in the cell when compared to the capacity mode to reduce a level of power consumption in the energy saving mode when compared to the capacity mode.

According to an embodiment, the base station is configured for supporting a plurality of different energy saving modes, the plurality comprising the energy saving mode; wherein the different energy saving modes deviate from one another in view of at least one of:
a remaining capability to receive and process wireless signals;
a capacity provided in the cell; and
an amount of electrical power consumed.

According to an embodiment, the base station is configured for informing the wireless communication network, e.g., a neighboring base station and/or a central entity, about a switch of an operation mode, the switch relating to at least one of:
switching into the energy saving mode; or into one of a plurality of different energy saving modes;
switching from the energy saving mode; or into one of a plurality of different energy saving modes; and/or
returning into the capacity mode.

According to an embodiment, the traffic capacity provided in the energy saving mode at least temporarily relates to a non-zero amount of signals scheduled by the base station in the cell to still serve a communicating device in the cell.

According to an embodiment, the traffic capacity provided in the energy saving mode at least temporarily relates to not transmit any signal by the base station; wherein the base station is configured to wirelessly receive and process a wake-up signal.

According to an embodiment, the base station, e.g., by use of a control unit that controls the base station accordingly, is configured for operating in different energy saving modes during different distinct time intervals, each energy saving mode associated with an individual associated power consumption of the base station and with an individual traffic capacity provided in the cell.

According to an embodiment, the base station, e.g., by use of a control unit that controls the base station accordingly, is configured to provide a high traffic capacity in the capacity mode, the high traffic being higher when compared to the energy saving mode, e.g. by using of all available bandwidth, all available antennas and/or maximum PSD.

According to an embodiment, when compared to the capacity mode, in the energy saving mode, the operation differs in at least one of:
components operated in the base station used for reception and/or transmission;
a duration of a SSB period;
a duration of a SIB-1 period
a number of neighbor cell measurements
a resolution or accuracy of measurements
a multiplexing pattern of a CORESET
a RACH capacity;
a paging capacity;
a number of used antenna ports or antenna panels;
a bandwidth usage
an applied Power Spectral Density; and
a prioritization of sleep modes for TRPs or cells.

According to an embodiment, in the capacity mode, the base station is configured for providing a large or high traffic capacity using at least one of:
a higher number of components of the base station used for reception and/or transmission;
a short SSB period, e.g. 20 ms;
a short SIB-1 transmission period, e.g. 20 ms in SSB/CORESET multiplexing pattern 1;
a high number of neighbor cell measurements
a high resolution or accuracy of measurements, e.g., high measurement bandwidth and/or short measurement periods
a large RACH capacity;
a large paging capacity;
a usage of all available antennas and antenna panels;
a usage of the complete available bandwidth;
a maximum Power Spectral Density; and
a lower priority for sleep modes for TRPs or cells.

According to an embodiment, in the energy saving mode, the base station is configured for providing a low or reduced energy consumption using at least one of:
a lower number of components of the base station used for reception and/or transmission;
a large or larger, when compared to the capacity mode, SSB period, e.g. 160 ms;
a large or larger, when compared to the capacity mode, SIB-1 period, e.g. 160 ms in SSB/CORESET multiplexing pattern 2;
a low number of neighbor cell measurements
a low resolution or accuracy of measurements, e.g., low measurement bandwidth and/or long measurement periods
a reduced RACH capacity with periodicity following SSB period;
a reduced paging capacity;
a subset of antenna ports or antenna panels turned off;
a reduced bandwidth usage;
a reduced Power Spectral Density; and
an optimized sleep modes for TRPs or cells.

According to an embodiment, the base station is configured for negotiating, with the wireless communication network, e.g., a network coordinator and/or a different base station, a value of at least operation parameter that is changed when switching to the energy saving mode.

According to an embodiment, in preparation to switch into the energy saving mode, the base station is configured for transmitting an energy saving message indicating at least one of:
a type or identifier of the energy saving mode;
an indication related to a time period, e.g., when and/or how long to change the operating mode;
a type of the operation mode, e.g., a type of the energy saving mode (e.g. deep sleep, light sleep, etc.)
a periodicity of broadcasted signals such as SSB, SIB-1 and/or other signals;
a time indication, e.g., as an offset or absolute, of broadcasted signals such as SSB, SIB-1 and/or other signals;
a serving cell and/or neighbor cell measurement parameter;
an on/off pattern indication for traffic channels, e.g., to support gNB discontinuous reception, DRX, and/or discontinuous transmission, DTX;
a time indication of a RACH configuration;
a paging configuration;
an intended bandwidth allocation, e.g., BWP or carrier;
an antenna configuration/antenna mode/beam configuration;
a Power Spectral Density (PSD) or transmit power;
an indication of a wake-up signal (WUS) from a UEs to a TRPs, along with received reception and power;
a potential bandwidth to be re-used by other gNBs; and
a possible lease time associated with a bandwidth used by the base station.

According to an embodiment, the base station is configured for supporting a plurality of different energy saving modes, the plurality comprising the energy saving mode; wherein a content of a message field of the energy saving message is specific for each of the energy saving modes.

According to an embodiment, a content of a message field of the energy saving message is specific for at least one of an uplink traffic, a downlink traffic and a sidelink traffic of the base station.

According to an embodiment, a control unit is configured for controlling the base station (a)) in the energy saving mode as a default operation mode and to temporarily switch from the default operation to the capacity mode based on an event; and/or
wherein the control unit is configured for controlling the base station (b)) in the capacity mode as a default operation mode and to temporarily switch from the default operation to the capacity mode based on an event.

According to an embodiment, the base station is adapted to switch between the energy saving mode and the capacity mode as the default operation, e.g., based on a time being either a daytime or nighttime and/or based on an expected traffic.

According to an embodiment, at least temporarily, a control unit is configured for controlling the base station (a)) in the energy saving mode as the default operation mode and to temporarily switch from the default operation to the capacity mode based on the event; wherein, in the default configuration, at least one of
a reduced bandwidth when compared to an available bandwidth;
a reduced number of antennas when compared to an available number of antennas at the base station; and
a reduced power spectral density, PSD, when compared to a reference PSD
   is used; wherein a bandwidth allocation follows a planned frequency reuse pattern, e.g., pattern 3 or 4, or a dynamic frequency reuse pattern.

According to an embodiment, the base station is configured to restore a planned frequency pattern 1 when switching back to the capacity mode.

According to an embodiment, the event relates to an increase of a load in the network cell that at least reaches a load threshold; and/or o a wake-up message received from the wireless communication network.

According to an embodiment, the base station is configured to switch to the capacity mode and to start a re-use of a bandwidth of a neighboring network cell in the capacity mode and to inform the wireless communication network about the intended re-use, e.g., to just inform others and/or to request confirmation or feedback.

According to an embodiment, the base station is configured for transmitting a first request message, e.g., signaling an energy saving state, ESS, to the wireless communication network indicating an antenna configuration intended to be used by the base station in the capacity mode. The ESS may be the energy saving mode as a single possible mode or may be one of a plurality of modes that is signaled.

According to an embodiment, the base station is configured for transmitting the first request message to information indicate an increased power spectral density, PSD, so that the neighbor cell is informed that more interference will be generated.

According to an embodiment, the base station is configured for transmitting the first request message to information indicate a lease time to indicate for how long at least a part of the resources used in the capacity mode, e.g., all resources or the additional resources, is planned to be re-used.

According to an embodiment, the base station is configured for transmitting the first request message or copies thereof to a plurality of neighboring base stations and to await a response message from each of the neighboring base stations.

According to an embodiment, the base station is configured for evaluating the response message for an indication relating to one of:
a rejection of the request by the neighboring base station indicating that the resource cannot or shall not be re-used;
a rejection of the request containing a different lease time when compared to a requested lease time and/or a different set of resources when compared to a requested set of resources;
an indication that the resource can be re-used while the neighboring base station answering will continue to operate in an energy saving mode or continue to operate in a capacity mode;
an indication that the request is accepted but the neighboring base station will also change from an energy saving mode to a capacity mode; or change from the capacity mode to the energy saving mode; and.
an indication that the request is accepted.

According to an embodiment, the base station is configured for operating according to the response message; or to negotiate with the neighboring base station at least one parameter indicated in the first request message that is rejected in the response message; or to transmit a message to the neighboring base station to reject the parameter indicated in the response message.

According to an embodiment, at least temporarily, a control unit is configured for controlling the base station (b)) in the capacity mode as a default operation mode and to temporarily switch from the default operation to the capacity mode based on an event; wherein in the energy saving mode, the event relates to the base station determining that the currently provided traffic capacity is not required.

According to an embodiment, the base station is configured for transmitting a second request message to at least one neighboring base station to indicate a planned switch into the energy saving mode based on the event.

According to an embodiment, in preparation of the switch to the energy saving mode, the base station is configured for initiating a handover of a served device to another base station.

According to an embodiment, the base station is configured for rejecting a received handover request when being in the energy saving mode.

According to an embodiment, the second request message contains a request to the at least one neighboring base station to stop using a band unused by the base station in the energy saving mode; and/or a request to the at least one neighboring base station to use the band with a reduced power.

According to an embodiment, the base station is configured to await a response to the second request message indicating a rejection of the request, an acceptance of the request or a counter-proposal to the request.

According to an embodiment, the base station is configured for receiving instructions, e.g., from O&M, that indicate a variable default operation mode; wherein the base station is configured for operating accordingly.

According to an embodiment, for an operation in the energy saving mode, the base station is configured for coordinating, e.g., in view of time, frequency and/or code, transmission of a broadcast signal for a cell search of a device with at least one different base station to operate, e.g., it may already operate in the ESS or may plan to operate in the ESS, in a corresponding energy saving mode.

According to an embodiment, the base station is configured for indicating, to a neighboring base station, an indication message indicating at least one of:
a time, e.g., absolute and/or relative when it will send or intends to send a broadcast message, e.g., an SSB burst;
an information indicating a periodicity of the broadcast message to be sent.

According to an embodiment, the base station is configured to expect, from the neighboring base station, a response message associated with the indication message, the response message indicating at least one of:
a configuration broadcast message timing, e.g., absolute, relative, offset from the indicated one;
a periodicity of the broadcast message of the neighboring base station.

According to an embodiment, the base station is configured for negotiating the time and/or periodicity per cell or per gNB.

According to an embodiment, the base station is configured for reconfiguring a plurality of user equipment, UE, connected to the base station to align their SSB based measurement timing configuration (SMTC) in the energy saving mode.

According to an embodiment, the base station is configured to switch from the capacity mode to the energy saving mode; and/or from the energy saving mode to the capacity mode based on an event, the event being associated with a determination performed by the base station, e.g., by measuring a load, determining a time or the like; and/or related to a control of a network orchestration and management (O&M).

According to an embodiment, the base station is configured to switch from the capacity mode to the energy saving mode and to inform a neighboring base station about the switch, e.g., using an ESS message or a different message.

According to an embodiment, the base station is configured to receive a message indicating that a neighboring base station enters an energy saving mode; and to increase a coverage of the cell to compensate for a reduction of coverage of the neighboring cell.

According to an embodiment, the base station is configured to respond to the message information indicating a power spectral density PSD and/or an antenna port configuration used for at least partly compensate for the reduction.

According to an embodiment, the base station is adapted to use a position information about a location, e.g., relative and/or absolute and/or a direction of a neighbor cell, e.g., azimuth, elevation and/or tilting, and for using the position information for taking over at least a part of a coverage a neighboring base station entering the energy saving mode.

According to an embodiment, the base station is adapted to obtain the position information in a message indicating that the neighboring base station intends to switch to the energy saving mode, e.g., an ESS message, or via a configuration by a network orchestration and management, O&M.

According to an embodiment, the base station is adapted to determine the position information based on a determination rule associating a base station identifier, e.g., gNB B, with the position information, e.g., a sector of the base station.

According to an embodiment, the base station is configured to receive, when operating in the energy saving mode, a signal such as a wake-up signal, and is configured to obtain power information that the base station has received the wake-up signal with a power level exceeding a predefined total power threshold, e.g., above a certain power level, or relative power threshold level, e.g., with a higher power than a neighbor base station, and to switch from the energy saving mode into the capacity mode based on the signal and the power information.

According to an embodiment, the base station is configured for individually in groupwise informing user equipment, UEs connected to the base station about a switch from the capacity mode to the energy saving mode, e.g., via RRC signaling.

According to an embodiment, the base station is configured for receiving a message from a neighboring base station indicating an intended switch of the neighboring base station into an energy saving mode, e.g., an ESS message, and for updating UEs connected to the base station and/or performing a handover from the neighboring base station to the base station with regard to at least one pre-configured mode, a change on a system information and/or a dedicated RRC message.

Embodiments provide for a base station for operating at least one cell of a wireless, e.g., radio based, communication network such as a 5G/NR communications network, the base station comprising:
wherein the base station is configured for receiving an indication signal, e.g., an ESS signal, indicating that a different, e.g., neighboring, base station of the wireless communication network intends to switch from an energy saving mode into a capacity mode that provides for a higher traffic capacity when compared to the energy saving mode; or intends to switch from the capacity mode into the energy saving mode;
wherein the base station is configured for transmitting a response signal to respond to the indication signal, the response signal containing information indicating an at least partial rejection of the switch and/or an at least partial confirmation of the switch.

According to an embodiment, the indication signal indicates a switch into the capacity mode and contains a request to at least temporarily use or re-use specific resources with the different base station.

According to an embodiment, the base station is configured for transmitting the response signal to indicate at least one of:
a rejection of the request indicating that the resource cannot or shall not be re-used;
a rejection of the request containing a different lease time when compared to a requested lease time and/or a different set of resources when compared to a requested set of resources;
an indication that the resource can be re-used while the base station will continue to operate in an energy saving mode or continue to operate in a capacity mode;
an indication that the request is accepted but the base station will also change from an energy saving mode to a capacity mode; or change from the capacity mode to the energy saving mode; and
an indication that the request is accepted.

According to an embodiment, the base station is configured for transmitting the response signal to indicate that the request is at least partially rejected by the base station and/or to contain a counter-proposal for the request.

According to an embodiment, the indication signal indicates a switch into the energy saving mode, wherein the indication signal requests a confirmation of the switch; wherein the base station is configured to transmit the response signal to contain information indicating a rejection of the request, the rejection being based on a number of resulting handovers.

According to an embodiment, the base station is configured for determining the rejection based on an information received from the different base station indicating whether the different base station will prevent idle devices to camp on a cell operated by the different base station and/or whether it will reject handovers from other base stations.

According to an embodiment, the base station is configured for indicating, in the response signal, to indicate a confirmation that the different base station is, at least temporarily, not a valid target for a handover.

Embodiments provide for a base station for operating at least one cell of a wireless, e.g., radio based, communication network such as a 5G/NR communications network, comprising:
wherein the base station is configured for obtaining information indicating that a neighboring base station switches to an energy saving mode in which the neighboring base station has a reduced coverage when compared to a capacity mode, and to compensate for the reduced coverage, e.g., based on a received corresponding request.

According to an embodiment, the base station is configured for transmitting a signal indicating an updated power spectral density, PSD, and/or an updated antenna port configuration implemented by the base station based on compensating the reduced coverage.

Embodiments provide for a user equipment, UE, configured for operating in a wireless communication network cell being operated by a serving base station, e.g., as in accordance with any of the preceding claims, wherein the UE is configured or pre-configured with different energy saving state, ESS, describing an operation of the UE when the serving base station is in an energy saving mode;
wherein the UE is adapted to switch between different configurations or pre-configurations based on a received signal, e.g., a lower layer signaling mechanism such as DCI or MAC element.

Embodiments provide for a wireless communication network comprising a plurality of base stations as described herein.

According to an embodiment, request messages indicating a request of a base station to switch from the energy saving mode to the capacity mode or to switch from the capacity mode to the energy saving mode comprise a structure that is individual for each cell of the wireless communication network, for each base station of the plurality of base stations and/or for each energy saving mode.

According to an embodiment, the wireless communication network comprises a network orchestration and management entity, O&M configured for individual, groupwise or globally within the wireless communication network define the capacity mode or the energy saving mode as a default operation mode from witch the base station temporarily switches to a different operation mode based on an event.

According to an embodiment, the O&M is adapted to vary the default operation mode, e.g., based on daytime/nighttime or based on an expected traffic.

According to an embodiment, at least temporarily and at least within a certain region of the wireless communication network at least a subset of the plurality of base stations is adapted to coordinate the operation mode to deviate from a pre-configured default operation mode set by a network orchestration and management entity.

According to an embodiment, a message indicating an intended switch of a bae station from the default operation mode, e.g., exchanged between neighboring base stations, is designed to reference a default configuration of a region or logical set of cells and/or to include differences to these configuration only.

According to an embodiment, at least temporarily and at least within a certain region of the wireless communication network an orchestration and management entity, O&M, of the wireless communication network is configured for monitoring a traffic and/or operation modes of base stations and is adapted to control the operation mode of the base stations accordingly.

Embodiments provide a method for operating a base station to operate at least one cell of a wireless communication network, the method comprising:
controlling the base station to operate the cell in a capacity mode during a first instance of time and in an energy saving mode during a different second instance of time;
such that, in the energy saving mode, the base station provides a lower traffic capacity in the cell when compared to the capacity mode to reduce a level of power consumption in the energy saving mode when compared to the capacity mode.

Embodiments provide a method for operating a base station to operate at least one cell of a wireless communication network, the method comprising:
receiving an indication signal indicating that a different, e.g., neighboring, base station of the wireless communication network intends to switch from an energy saving mode into a capacity mode that provides for a higher traffic capacity when compared to the energy saving mode; or intends to switch from the capacity mode into the energy saving mode; and
transmitting a response signal to respond to the indication signal, the response signal containing information indicating an at least partial rejection of the switch and/or an at least partial confirmation of the switch.

Embodiments provide a method for operating a base station to operate at least one cell of a wireless communication network, the method comprising:
obtaining information indicating that a neighboring base station switches to an energy saving mode in which the neighboring base station has a reduced coverage when compared to a capacity mode, and
compensating for the reduced coverage, e.g., based on a received corresponding request.

Embodiments provide a method for operating a user equipment, UE, in a wireless communication network cell being operated by a serving base station, e.g., as in accordance with any of the preceding claims, wherein the UE is configured or pre-configured with different energy saving state, ESS, describing an operation of the UE when the serving base station is in an energy saving mode, the method comprising:

switching the UE between different configurations or pre-configurations based on a received signal, e.g., a lower layer signaling mechanism such as DCI or MAC element.

Embodiments provide a computer program for performing a method as described herein, when the computer program runs on a computer, microprocessor or software.

In known networks, the design leads to a power consumption during the night which is much larger than needed. Also during the day, in areas with less traffic the peak capacity is scarcely needed while the power consumption is barely reduced in the absence of traffic

Embodiments relate to the goal of saving energy. To achieve this, some embodiments relate to one or more of:
gNBs that exchange messages to coordinate their BWP/CC, PSD and/or antenna configurations aiming at 2 or more completely different sets of configurations: 1 for maximum throughput at peak traffic, 1 for maximum energy savings at lowest traffic and possibly further or intermediate configuration
Model A—the default operation mode may be energy saving state. A gNB may inform others it needs to go to high traffic mode.
Model B—the default operation mode may be high traffic mode. A gNB may inform others it needs to go to energy saving mode.
Based on the response the gNB may inform UEs to use energy saving or high traffic mode configurations.

With regard to the goal to save energy, the inventors found that a considerable or even the largest part of the energy consumption occurs in the Radio Access Network (RAN). The inventors found that diverse energy saving states might be supported by a base station, which possibly benefit from being coordinated.

The main legacy mechanism for energy savings in 5G NR networks is the possibility to switch cells on and off as described in TS 38.300 and TS 38.423. In essence, a gNB can send a “Deactivation Indication” to inform neighbors that a certain cell was switched off to lower energy consumption. Conversely, a gNB may send a “Cell Activation Request” to a neighbor node to request the re-activation of a cell which was earlier switched off. That request may succeed in which case it is answered with a “Cell Activation Response” or it may fail in which case it is answered with a “Cell Activation Failure”.

This mechanism is mostly applicable to heterogeneous networks where small cells can inform a macrocell that will be turned off to save energy. At a later moment, for example due to increased traffic the macrocell can request the small cells to turn on again. The main disadvantages of such Xn signaling are:
A cell can only be fully on or fully off (there is no intermediate state)
It does not support macrocell coordination
It does not support parameter negotiation
It does not support advanced joint-domain techniques (joint adaptation in power, frequency, space and time domains)

Based thereon, the solutions defined in the presented embodiments provides for gNBs in a mobile communication system that exchange messages to inform each other about changes in their Energy Saving State (ESS). As an example, 2 ESSs may be defined: a regular operation mode or capacity mode and an energy saving mode.

Such exchange of information is based on an implementation of a base stations that same may switch between the capacity mode and the energy saving mode and possibly or advantageously inform other participants, gNBs, central entities and/or UEs about the change or intended change.

In the regular operation mode or capacity mode the network or at least the gNB or base station may aim at providing a high or even maximal capacity, i.e., at least a capacity larger or higher than in the energy saving mode, using for example at least one or some of the following options:
A short SSB period, e.g. 20 ms
A short SIB-1 transmission period, e.g. 20 ms in SSB/CORESET multiplexing pattern 1
High number of neighbor cell measurements
High measurement accuracy (e.g. higher bandwidth and shorter periods)
Large RACH capacity
Large paging capacity
Usage of all available antennas and antenna panels
Usage of the complete available bandwidth
Maximum Power Spectral Density
Less priority for sleep modes for TRPs or cells

As high capacity, one may understand to provide a capacity being higher when compared to the energy saving mode, e.g. by using more or all available bandwidth, more or all available antennas and/or a higher or even maximum PSD.

In contrast, an energy saving mode may be defined to provide low or even minimal (non-zero as still being in operation) energy consumption being lower or reduced when compared to the capacity mode using at least one out of following options:
A large SSB period, e.g. 160 ms
A large SIB-1 period, e.g. 160 ms in SSB/CORESET multiplexing pattern 2
Reduced number of neighbor cell measurements
Lower measurement accuracy
Reduced RACH capacity with periodicity following SSB period
Reduced paging capacity
Some antenna ports or antenna panels turned off
Reduced bandwidth usage
Reduced Power Spectral Density
Optimized sleep modes for TRPs or cells

In the energy saving mode, the base station may still be operational, e.g., by providing a remaining traffic capacity provided in the energy saving mode is at least temporarily related to a non-zero amount of signals scheduled by the base station in the cell to still serve a communicating device in the cell and/or the traffic capacity provided in the energy saving mode at least temporarily relates to not transmit any signal by the base station; wherein the base station is configured to wirelessly receive and process a wake-up signal.

According to embodiments, more modes can be defined with intermediate configurations between regular operation mode and the energy saving mode, e.g. where some components of a base station might be switched off or limiting the functionality temporarily reception or transmission only.

In order to optimize the network performance and energy savings, the gNBs may exchange ESS messages to inform and or negotiate parameters with at least one other gNB.

An ESS message may include one or more of the following fields:
Indication of time period when and how long to change to sleep mode, e.g. a starting time (either absolute time, when to change to which type of sleep mode with the option to indicate when to return to regular operation mode (absolute time stamp or relative time period) or a relative time (e.g. in x minute, y seconds)
Type of energy saving mode (e.g. deep sleep, light sleep, etc.)
The periodicity of broadcasted signals (SSB, SIB-1, other signals)
A time indication (offset or absolute) of broadcasted signals (SSB, SIB-1, other signals)
Serving and neighbor cell measurements and/or parameters/settings
An on/off pattern indication e.g. for traffic channels, to support gNB DRX/DTX (optionally, this may also be implicitly tied to SSB period)
A time indication of RACH configuration
Paging configuration
Intended bandwidth allocation (e.g. BWP or carrier)
Antenna configuration/antenna mode/beam configuration
Power Spectral Density (PSD) or transmit power
Indication of wakeup signal (WUS) from UEs to TRPs, along with received reception and power
Potential bandwidth (carrier, BWP, etc.) to be re-used by other gNBs and/or possible lease time

In an embodiment, the base station may signal, e.g., using the ESS message, the beam configuration, and especially or even most particularly of at least one SSB beam. That is, the BS may be configured for transmitting an energy saving message, ESM, indicating a beam configuration, e.g., of at least one SSB.

The fields of the ESS message may be specified for each cell, per gNB for each ESS mode. Bandwidth and PSD may be separately indicated for uplink and/or downlink and/or sidelink.

However, such an ESS message may also be considered as a kind of request that may requests a change in an operation of a different network participant. Such a request may be partially or fully be accepted or partially or fully be rejected, possibly accompanied with a kind of counter-proposal and/or other types of negotiations.

A couple of protocol variants can be defined for the ESS message exchange among gNBs Amongst them there are options according to which:
a) A cell is by default at low energy consumption ESS and the gNB sends an ESS message to a neighbor gNB when moving to a higher energy consumption mode.
b) A cell is by default on a high capacity mode (high energy consumption ESS) and sends ESS message to inform neighbors when it is about to move to a lower energy consumption model
c) Hybrid—e.g. model a) is applied during night time or if lower traffic is to be expected and model b) during daytime or if higher traffic is to be expected.

This different protocol variants are described in slightly more detail on the following subsections. Furthermore, different aspects will be discussed later.

### Low Energy Consumption by Default

In accordance with embodiments, this configuration or model the gNBs by default may use a configuration with reduced bandwidth, reduced number of antennas and/or reduced power spectral density, PSD. The bandwidth allocation during low energy consumption mode may follow a planned frequency reuse pattern (e.g. 3, 4) or a dynamic frequency reuse. This is in contrast to the typical deployment of 3G, 4G and 5G networks where a frequency reuse 1 is used. The frequency reuse can increase the received SINR to compensate reduced PSD or reduced number of antennas. Note that when moving/switching back to high capacity mode, one of the first adaptations may be to restore reuse 1, which may allow for or even be essential for maximum capacity.

According to embodiments, when, for example, the load is increased and the gNB cannot serve the traffic with the existing configuration, the gNB may send an ESS message to a neighbor to start reusing the same bandwidth of the neighbor cell. An antenna configuration indication may inform that the requesting gNB can take over more coverage and more traffic. This request message may also indicate an increased PSD so that the neighbor cell is informed that more interference will be generated. Furthermore the request message may include a “lease time” to indicate the neighbors for how long the resources are planned to be reused. For example, a gNB may send this ESS request to several neighbor cells, each of them providing a response.

The gNB may inform others about its intentioned operation and optionally may inform the others as a request. That is, the informing/requesting gNB may, in one embodiment merely inform the other gNBs that it will start reusing their bandwidth. According to another embodiment the requesting/informing gNB requests a permission to re-use the bandwidth from other gNBs. In this case, the other gNBs may acknowledge or reject the request and/or send a counter-proposal. Both embodiments may be combined, e.g., operating differently in different operating modes or configurations.

In response to an ESS request message, a gNB may have some different options:
Reject the request (the resource cannot be reused).
Reject the request but offer a new lease time and/or new set of resources.
Indicate that the resource can be reused while the answering gNB will keep the same ESS mode. For example:
   Keep low energy ESS mode (the cells from the answering gNB will not reuse the bandwidth from the requesting gNB).
   Keep high capacity ESS mode (the cells from the answering gNB are already reusing the same resources and will continue to use them).
Indicate that the request is accepted but the answering gNB will also change the ESS mode. For example:
   Change from low energy ESS to high capacity ESS (e.g. the cells from the answering gNB will reuse the bandwidth from the requesting gNB).
   Change from high capacity ESS to low energy ESS (e.g. the cells from the answering gNB will then need to carry less traffic).

The protocol may include a third message where the counter-proposal of the answering gNB is either acknowledged or rejected.

### High Capacity by Default

A configuration in which the gNB operates in the capacity mode by default may be similar to that of the Cell Activation procedure as described in TS 38.300, clause 15.4.2 (signaling over Xn is specified in TS 38.423, 8.4.3 and 9.1.3.7/8/9: cell activation request/response/failure).

However, embodiments provide, amongst others, for a difference that a cell would move/switch to a lower energy state which still can serve users, instead of being completely off. Also, the legacy mechanism is hierarchical, i.e. macrocells control small cells. Instead, a mechanism in accordance with embodiments may implemented to negotiate parameters among equal cells.

According to an embodiment, a gNB determining that its capacity is not needed may decide to go into low energy ESS mode. In this case, the gNB may inform other/neighboring gNBs about this decision, e.g., via ESS signaling, and/or may initiate handover or other signaling. The answering cells may reject the request, for example because too many handovers would be needed. The requesting gNB may indicate if it will prevent idle UEs to camp on this cell (cell barring or even SSB-less operation) and reject handovers from other gNBs. For example, the answering gNB may reconfigure system information to reflect that the neighbor is not a valid target anymore.

In case the other gNBs again need the capacity of the low power ESS gNB, they may request a cell reactivation (or ESS wake up) from low energy ESS mode to a node which previously signaled to enter lower energy mode.

Another enhancement to Xn protocol that is provided by embodiments is the possibility that gNBs may negotiate the parameters of the ESS mode. For example, a gNB may inform the neighbor that will use a reduced bandwidth for a certain cell in a lower ESS mode. Nevertheless, to cope with this reduced bandwidth the ESS message may indicate a request that the neighbor cell(s) stop(s) using this band (dynamic reuse) or use it only with reduced power (fractional frequency reuse). In this way, the SINR may be increased and the gNB on ESS can have enough capacity to operate even with reduced band. The responding gNB may then reject the request (partially or completely), accept the request (partially or completely) and/or make a counter-proposal.

The decision to go to low power ESS mode or vice versa for a gNB may also be initiated by network O&M (Orchestration and Management).

The described mechanisms may relate to the default operation modes but may also be implemented independently from the default operation, e.g., when switching back from a non-default operation to the default operation and/or to another non-default operation mode.

### Hybrid Model

The described models of section low energy consumption by default and high capacity by default and/or derivates thereof may also be combined. For example, during the day the gNBs are by default on a high capacity ESS unless they signal to other gNBs. Conversely, during the night the gNBs are, for example, by default on a low energy ESS unless they signal to other gNBs. The exact day and night times could be set on gNBs, e.g. via O&M. Also, more than 2 ESSs are possible, so that basically during each time of the day a pre-programmed ESS is applicable. Alternatively or in addition, other criteria may be used to set a predefined default operation mode, e.g., based on an expected (future) traffic.

For example, the gNBs may apply the model of section low energy consumption by default when they need to support more traffic and acquire more resources than on current ESS. Also, the gNBs can apply the model of section high capacity by default when they have more capacity than needed and could then save energy.

### Time Coordination of Broadcasted Signals

The discovery of cells for the sake of initial cell search or target search may be coordinated by neighbor gNBs. Embodiments allow that UEs may receive broadcast signals from different cells at acceptable power levels because such broadcast signals are typically designed to have a very large coverage. Particularly, in initial cell search it may be enough that the UE find any cell, not necessarily the best cell. If gNBs are using an ESS with more sparse always-on broadcast signals, they can coordinate when to transmit broadcast signals (e.g. SSB) in order to maximize the chance that the UE will at any point in time find a broadcast signal. In order to achieve such alignment, a gNB may send an indication of the time (absolute and/or relative) when it will send a broadcast such as an SSB burst and/or the associated periodicity. At least one different gNB may answer on such information. The answering gNB may, for example, indicate its own configuration SSB burst timing (absolute, relative, offset from the other one) and/or associated periodicity. For example, at least one of the gNBs may adapt their schedule, e.g., to obtain a pattern of broadcast signals in the time domain. The SSB timings may be defined per cell or per gNB.

The same or a similar principle may be applicable to create the time coordination for other broadcast signals. For example, in 4G LTE there is not an SSB concept but this principle can be used to align PSS/SSS among different eNBs. Also CSI-RS may be aligned to facilitate UEs RRM measurements. In this case, the gNB may reconfigure the UEs to align their SMTC (SSB based measurement timing configuration) to the new aligned measurement.

### Requests to Take Over Coverage

According to an embodiment, when a cell goes into a lower ESS, there may be some loss of coverage, for example because the cell may have reduced PSD and/or antenna port adaptation (e.g., a usage of less beams or beams with lower coverage). In embodiments, such a coverage loss may be compensated by other cells if they are aware of the change. In such a scenario a gNB may send a message to a neighbor gNB informing of the reduced coverage and an indication that the neighbor gNB is requested to increase its coverage as a compensation. The requested gNB may or may not send a response. An example response may include a new PSD and antenna port configuration from the responding gNB.

In several deployment scenarios according to embodiments, in order to take over coverage a gNB is advantageously made aware of a location (relative and/or absolute) and/or a direction of the neighbor cell (e.g., azimuth, elevation and/or tilting). This information may be included, for example, in ESS messages and/or configured by O&M. It may, as an alternative or in addition, be translated to a rule format: for example, if gNB “A” receives a request to take over coverage from gNB “B”, then, according to the example, it should increase PSD on cell A.2 (but possibly do nothing on A.1 and A.3). Such rules may be created by an Al/ML algorithm, e.g., as static or dynamic rules.

### Distributed Multi-TRP Reception of Wake Up Signal

When the UEs sending a WUS, requesting at least one TRP and/or cell to wake up from a sleep mode or to restore regular operation from an energy saving state, do not have an estimate of the propagation losses (e.g., pathloss and shadowing constituting the large-scale link gain typically estimated from synchronization signals) needed for uplink power control, the transmission of WUS may be performed with maximum allowed PSD. In such case, e.g., when multiple TRPs receive the WUS, the TRPs may exchange, e.g., via ESS messages, the indication of WUS reception including the respective power levels for aiding the decision of which TRP should wake up. That is, not every gNB receiving a wakeup signal is required to wake up. In this way, according to embodiments each gNB can know if it has received WUS at a higher power level than its neighbors or not. According to an embodiment, if the WUS power is the highest among the neighbors the gNB may perform a wake-up for that cell and restore high capacity ESS. If not, i.e., other cells, may continue on low energy ESS.

### Configuration Update on the UEs

According to an embodiment, the UEs may be updated individually or in one or more groups regarding the ESS mode change for example via RRC signaling.

According to an embodiment, the UEs may be also pre-configured with different ESS modes, and a lower layer signaling mechanism such as DCI or MAC element may be used to switch the pre-configured ESS modes.

According to an embodiment, upon reception of an ESS message, the gNB may update the UEs with the pre-configured modes, changes on system information and/or dedicated RRC messages.

### Hybrid Model with Network Defaults

This section may extend the embodiments described in section “Hybrid model”.

According to an embodiment, network operators may configure their network and cells according to very specific KPIs and/or strategic goals (e.g., using network orchestration and management). Therefore, according to an embodiment, one, some or all base stations of the wireless communication network may have a ‘default’ configuration. This default configuration may be specific to a certain cell, a specific gNB/eNB, groups thereof, a location or region and/or may also differ according to a schedule defined by the network operator.

According to an embodiment, at least within a certain region (i.e. control region) gNBs/eNBs may be adapted to coordinate, thus exchange ESS information, whenever the configuration changes or differs from the pre-configured default set by the network operator.

According to an embodiment, ESS messages may be designed to reference a default configuration of a region or logical set of cells and include the differences to these configuration only, i.e., they may transmit a delta-information.

### Centralized Approach

Any of the above described embodiments may be based on ESS message exchange among neighbor cells or base stations, gNBs. This can be seen as a de-centralized approach. A centralized approach is, as an alternative or in addition, also possible, e.g. by involving the O&M center or other central entities of the wireless communication network. For example, the centralized entity, e.g., the O&M center, may monitor the traffic situation and/or ESS modes, may controls and/or change the ESS modes of one, some or all gNBs in the network, accordingly.

Embodiments of the present invention enable a coordination of gNBs to minimize energy consumption while attaining still high network performance. This coordination allows to achieve a good or even the best trade-offs dynamically.

Embodiments may be implemented but are not restricted to a use in cellular networks such as 5G NR and/or 4G LTE.

Various elements and features of the present invention may be implemented in hardware using analog and/or digital circuits, in software, through the execution of instructions by one or more general purpose or special-purpose processors, or as a combination of hardware and software. For example, embodiments of the present invention may be implemented in the environment of a computer system or another processing system. FIG. 7 illustrates an example of a computer system 500. The units or modules as well as the steps of the methods performed by these units may execute on one or more computer systems 500. The computer system 500 includes one or more processors 502, like a special purpose or a general-purpose digital signal processor. The processor 502 is connected to a communication infrastructure 504, like a bus or a network. The computer system 500 includes a main memory 506, e.g., a random-access memory (RAM), and a secondary memory 508, e.g., a hard disk drive and/or a removable storage drive. The secondary memory 508 may allow computer programs or other instructions to be loaded into the computer system 500. The computer system 500 may further include a communications interface 510 to allow software and data to be transferred between computer system 500 and external devices. The communication may be in the form of electronic, electromagnetic, optical, or other signals capable of being handled by a communications interface. The communication may use a wire or a cable, fiber optics, a phone line, a cellular phone link, an RF link and other communications channels 512.

The terms “computer program medium” and “computer readable medium” are used to generally refer to tangible storage media such as removable storage units or a hard disk installed in a hard disk drive. These computer program products are means for providing software to the computer system 500. The computer programs, also referred to as computer control logic, are stored in main memory 506 and/or secondary memory 508. Computer programs may also be received via the communications interface 510. The computer program, when executed, enables the computer system 500 to implement the present invention. In particular, the computer program, when executed, enables processor 502 to implement the processes of the present invention, such as any of the methods described herein. Accordingly, such a computer program may represent a controller of the computer system 500. Where the disclosure is implemented using software, the software may be stored in a computer program product and loaded into computer system 500 using a removable storage drive, an interface, like communications interface 510.

The implementation in hardware or in software may be performed using a digital storage medium, for example cloud storage, a floppy disk, a DVD, a Blue-Ray, a CD, a ROM, a PROM, an EPROM, an EEPROM or a FLASH memory, having electronically readable control signals stored thereon, which cooperate (or are capable of cooperating) with a programmable computer system such that the respective method is performed. Therefore, the digital storage medium may be computer readable.

Some embodiments according to the invention comprise a data carrier having electronically readable control signals, which are capable of cooperating with a programmable computer system, such that one of the methods described herein is performed.

Generally, embodiments of the present invention may be implemented as a computer program product with a program code, the program code being operative for performing one of the methods when the computer program product runs on a computer. The program code may for example be stored on a machine-readable carrier.

Other embodiments comprise the computer program for performing one of the methods described herein, stored on a machine-readable carrier. In other words, an embodiment of the inventive method is, therefore, a computer program having a program code for performing one of the methods described herein, when the computer program runs on a computer.

A further embodiment of the inventive methods is, therefore, a data carrier (or a digital storage medium, or a computer-readable medium) comprising, recorded thereon, the computer program for performing one of the methods described herein. A further embodiment of the inventive method is, therefore, a data stream or a sequence of signals representing the computer program for performing one of the methods described herein. The data stream or the sequence of signals may for example be configured to be transferred via a data communication connection, for example via the Internet. A further embodiment comprises a processing means, for example a computer, or a programmable logic device, configured to or adapted to perform one of the methods described herein. A further embodiment comprises a computer having installed thereon the computer program for performing one of the methods described herein.

In some embodiments, a programmable logic device (for example a field programmable gate array) may be used to perform some or all of the functionalities of the methods described herein. In some embodiments, a field programmable gate array may cooperate with a microprocessor in order to perform one of the methods described herein. Generally, the methods may be performed by any hardware apparatus.

While this invention has been described in terms of several embodiments, there are alterations, permutations, and equivalents which fall within the scope of this invention. It should also be noted that there are many alternative ways of implementing the methods and compositions of the present invention. It is therefore intended that the following appended claims be interpreted as including all such alterations, permutations and equivalents as fall within the true spirit and scope of the present invention.

### LIST OF REFERENCES

[1] Xu et al “Understanding Mobile Traffic Patterns of Large Scale Cellular Towers in Urban Environment,” in IEEE/ACM Transactions on Networking, vol. 25, no. 2, pp. 1147-1161 April 2017

### ABBREVIATIONS

3GPP third generation partnership project
ACK acknowledgement
AIM assistance information message
AMF access and mobility management function
BS base station
BWP bandwidth part
CA carrier aggregation
CC component carrier
CBG code block group
CBR channel busy ratio
CQI channel quality indicator
CSI-RS channel state information-reference signal
CN core network
D2D device-to-device
DAI downlink assignment index
DCI downlink control information
DL downlink
DRX discontinuous reception
ESS Energy Saving State
FFT fast Fourier transform
FR1 frequency range one
FR2 frequency range two
GMLC gateway mobile location center
gNB evolved node B (NR base station)/next generation node B base station
GSCN global synchronization channel number
HARQ hybrid automatic repeat request
ICS initial cell search
IoT internet of things
LCS location services
LMF location management function
LPP LTE positioning protocol
LTE long-term evolution
MAC medium access control
MCR minimum communication range
MCS modulation and coding scheme
MIB master information block
NACK negative acknowledgement
NB node B
NES network energy saving
NR new radio
NTN non-terrestrial network
NW network
OFDM orthogonal frequency-division multiplexing
OFDMA orthogonal frequency-division multiple access
PBCH physical broadcast channel
P-UE pedestrian UE; not limited to pedestrian UE, but represents any UE with a need to save power, e.g., electrical cars, cyclists,
PC5 interface using the sidelink channel for D2D communication
PDCCH physical downlink control channel
PDSCH physical downlink shared channel
PLMN public land mobile network
PPP point-to-point protocol
PPP precise point positioning
PRACH physical random access channel
PRB physical resource block
PSFCH physical sidelink feedback channel
PSCCH physical sidelink control channel
PSSCH physical sidelink shared channel
PUCCH physical uplink control channel
PUSCH physical uplink shared channel
RAIM receiver autonomous integrity monitoring
RAN radio access networks
RAT radio access technology
RB resource block
RNTI radio network temporary identifier
RP resource pool
RRC radio resource control
RS reference symbols/signal
RTT round trip time
SBI service based interface
SCI sidelink control information
SI system information
SIB sidelink information block
SL sidelink
SPI system presence indicator
SSB synchronization signal block
SSR state space representations
TB transport block
TTI short transmission time interval
TDD time division duplex
TDOA time difference of arrival
TIR target integrity risk
TRP transmission reception point
TTA time-to-alert
TTI transmission time interval
UCI uplink control information
UE user equipment
UL uplink
UMTS universal mobile telecommunication system
V2x vehicle-to-everything
V2V vehicle-to-vehicle
V2I vehicle-to-infrastructure
V2P vehicle-to-pedestrian
V2N vehicle-to-network
V-UE vehicular UE
VRU vulnerable road user
WUS wake-up signal

1.-70. (canceled)

71. A base station for operating at least one cell of a wireless communication network, comprising:
wherein the base station is to operate the cell in a capacity mode during a first instance of time and in an energy saving mode during a different second instance of time;
wherein, in the energy saving mode, the base station provides a lower traffic capacity in the cell when compared to the capacity mode to reduce a level of power consumption in the energy saving mode when compared to the capacity mode,
wherein in preparation to switch into the energy saving mode, the base station is configured for transmitting an energy saving message, ESM, indicating a beam configuration, e.g., of at least one SSB beam.

72. The base station of claim 71, wherein the base station is configured for informing the wireless communication network, e.g., a neighboring base station and/or a central entity, about a switch of an operation mode, the switch relating to at least one of:
switching into the energy saving mode; or into one of a plurality of different energy saving modes;
switching from the energy saving mode; or into one of a plurality of different energy saving modes; and/or
returning into the capacity mode.

73. The base station of claim 72, wherein the traffic capacity provided in the energy saving mode at least temporarily relates to not transmit any signal by the base station; wherein the base station is configured to wirelessly receive and process a wake-up signal.

74. The base station of claim 71, wherein, in the capacity mode, the base station is configured for providing a large or high traffic capacity using at least one of:
a higher number of components of the base station used for reception and/or transmission;
a short SSB period, e.g. 20 ms;
a short SIB-1 transmission period, e.g. 20 ms in SSB/CORESET multiplexing pattern 1;
a high number of neighbor cell measurements
a high resolution or accuracy of measurements, e.g., high measurement bandwidth and/or short measurement periods
a large RACH capacity;
a large paging capacity;
a usage of all available antennas and antenna panels;
a usage of the complete available bandwidth;
a maximum Power Spectral Density; and
a lower priority for sleep modes for TRPs or cells.

75. The base station of claim 71, wherein, in the energy saving mode, the base station is configured for providing a low or reduced energy consumption using at least one of:
a lower number of components of the base station used for reception and/or transmission;
a large SSB period, e.g. 160 ms;
a large SIB-1 period, e.g. 160 ms in SSB/CORESET multiplexing patern 2;
a low number of neighbor cell measurements
a low resolution or accuracy of measurements, e.g., low measurement bandwidth and/or long measurement periods
a reduced RACH capacity with periodicity following SSB period;
a reduced paging capacity;
a subset of antenna ports or antenna panels turned off;
a reduced bandwidth usage;
a reduced Power Spectral Density; and
an optimized sleep modes for TRPs or cells.

76. The base station of claim 71, wherein in preparation to switch into the energy saving mode, the base station is configured for transmitting an energy saving message indicating at least one of:
a type or identifier of the energy saving mode;
an indication related to a time period, e.g., when and/or how long to change the operating mode;
a type of the operation mode, e.g., a type of the energy saving mode (e.g. deep sleep, light sleep, etc.)
a periodicity of broadcasted signals such as SSB, SIB-1 and/or other signals;
a time indication, e.g., as an offset or absolute, of broadcasted signals such as SSB, SIB-1 and/or other signals;
a serving cell and/or neighbor cell measurement parameter;
an on/off pattern indication for traffic channels, e.g., to support gNB discontinuous reception, DRX, and/or discontinuous transmission, DTX;
a time indication of a RACH configuration;
a paging configuration;
an intended bandwidth allocation, e.g., BWP or carrier;
an antenna configuration/antenna mode/beam configuration;
a Power Spectral Density (PSD) or transmit power;
an indication of a wakeup signal (WUS) from a UEs to a TRPs, along with received reception and power;
a potential bandwidth to be re-used by other gNBs; and
a possible lease time associated with a bandwidth used by the base station.

77. The base station of claim 71, wherein the base station (a)) is to operate in the energy saving mode as a default operation mode and to temporarily switch from the default operation to the capacity mode based on an event; and/or
wherein the base station (b)) is to operate in the capacity mode as a default operation mode and to temporarily switch from the default operation to the capacity mode based on an event.

78. The base station of claim 77, wherein the base station is adapted to switch between the energy saving mode and the capacity mode as the default operation, e.g., based on a time being either a daytime or nighttime and/or based on an expected traffic.

79. The base station of claim 77, wherein, at least temporarily, the base station (b)) is to operate in the capacity mode as a default operation mode and to temporarily switch from the default operation to the capacity mode based on an event; wherein in the energy saving mode, the event relates to the base station determining that the currently provided traffic capacity is not required.

80. The base station of claim 79, wherein, in preparation of the switch to the energy saving mode, the base station is configured for initiating a handover of a served device to another base station.

81. The base station of claim 79, wherein the base station is configured for rejecting a received handover request when being in the energy saving mode.

82. The base station of claim 71, wherein for an operation in the energy saving mode, the base station is configured for coordinating transmission of a broadcast signal for a cell search of a device with at least one different base station to operate in a corresponding energy saving mode.

83. The base station of claim 82, wherein the base station is configured for indicating, to a neighboring base station, an indication message indicating at least one of:
a time, e.g., absolute and/or relative when it will send or intends to send a broadcast message, e.g., an SSB burst;
an information indicating a periodicity of the broadcast message to be sent.

84. Method for operating a base station to operate at least one cell of a wireless communication network, the method comprising:
controlling the base station to operate the cell in a capacity mode during a first instance of time and in an energy saving mode during a different second instance of time;
such that, in the energy saving mode, the base station provides a lower traffic capacity in the cell when compared to the capacity mode to reduce a level of power consumption in the energy saving mode when compared to the capacity mode; and
such that in preparation to switch into the energy saving mode, the base station transmits an energy saving message, ESM, indicating a beam configuration, e.g., of at least one SSB beam.

85. Computer program for performing a method as claimed in claim 84, when the computer program runs on a computer, microprocessor or software defined radio.
